(19) United States
(12) Patent Application Publication
(10) Pub. No.: US 2019/0331797 A1
(43) Pub. Date: Oct. 31, 2019

(54) ALTERNATING CHIRP FREQUENCY MODULATED CONTINUOUS WAVE DOPPLER LIDAR

(71) Applicant: GM Global Technology Operations LLC, Detroit, MI (US)

(72) Inventors: Scott Singer, San Gabriel, CA (US); Lutfollah (Lute) Maleki, Pasadena, CA (US); Alexander Standridge, Westlake Village, CA (US)

(21) Appl. No.: 15/962,190

(22) Filed: Apr. 25, 2018

(51) Int. Cl. G01S 17/58; G01S 7/497; G01S 7/481

(52) U.S. Cl. CPC G01S 17/58; G01S 7/4813; G01S 7/497

(57) ABSTRACT

A coherent lidar system includes a first light source and a second light source to respectively output a first continuous wave and a second continuous wave, and a first modulator and a second modulator to respectively modulate a frequency of the first continuous wave and the second continuous wave to respectively provide a first frequency modulated continuous wave (FMCW) signal and a second FMCW signal. The system also includes a beam combiner to combine the first FMCW signal and the second FMCW signal into a combined FMCW signal, and one or more aperture lenses to transmit an output signal obtained from the combined FMCW signal and to obtain a return signal resulting from a reflection of the output signal by a target.

### INTRODUCTION

The subject disclosure relates to alternating chirp frequency modulated continuous wave (FMCW) Doppler light detection and ranging (lidar).

Vehicles (e.g., automobiles, trucks, construction equipment, farm equipment, automated factory equipment, aircraft) increasingly include sensors that obtain information about the vehicle operation and the environment around the vehicle. The sensors may facilitate augmentation of vehicle operation or fully autonomous vehicles. Some sensors, such as cameras, radio detection and ranging (radar) systems, and lidar systems can detect and track objects in the vicinity of the vehicle by determining the relative location and heading of objects around the vehicle. When a radar or lidar signal is transmitted, the frequency shift in the return signal that is reflected by a target, as compared with the transmitted signal, is referred to as the Doppler effect. This Doppler shift facilitates the determination of relative speed and direction of travel of the target. Generally, an FMCW light signal is generated by modulating the frequency of light produced by a light source to increase or decrease linearly. In a coherent lidar system, the transmitted waveform, referred to as a chirp, may be generated as a triangle wave using a combination of modulations resulting in a frequency increase (upchirp) and frequency decrease (downchirp). In the return signal, the shift in frequency during the upchirp and the shift in frequency during the downchirp are used to determine range and relative velocity of the target. If two chirps were transmitted simultaneously, the resulting return signal would either decrease processing time or increase signal-to-noise ratio (SNR). Accordingly, it is desirable to provide an alternating chirp FMCW Doppler lidar.

### SUMMARY

In one exemplary embodiment, a coherent lidar system includes a first light source and a second light source to respectively output a first continuous wave and a second continuous wave, and a first modulator and a second modulator to respectively modulate a frequency of the first continuous wave and the second continuous wave to respectively provide a first frequency modulated continuous wave (FMCW) signal and a second FMCW signal. The system also includes a beam combiner to combine the first FMCW signal and the second FMCW signal into a combined FMCW signal, and one or more aperture lenses to transmit an output signal obtained from the combined FMCW signal and to obtain a return signal resulting from a reflection of the output signal by a target.

In addition to one or more of the features described herein, the first FMCW signal is a first triangle wave with increasing frequency followed by decreasing frequency and the second FMCW signal is a second triangle wave with decreasing frequency followed by increasing frequency.

In addition to one or more of the features described herein, the first triangle wave and the second triangle wave are concurrent in the combined FMCW signal such that the increasing frequency in the first triangle wave is simultaneous with the decreasing frequency in the second triangle wave and the decreasing frequency in the first triangle wave is simultaneous with the increasing frequency in the second triangle wave.

In addition to one or more of the features described herein, the system also includes a beam splitter to split the combined FMCW signal into the output signal and a local oscillator (LO) signal.

In addition to one or more of the features described herein, the system also includes an alignment element to align the LO signal and the return signal to produce a co-linear signal.

In addition to one or more of the features described herein, the system also includes two or more photodetectors to obtain an interference result based on interference between the LO signal and the return signal in the co-linear signal.

In addition to one or more of the features described herein, the return signal includes a first component associated with the first FMCW signal in the output signal and a second component associated with the second FMCW signal in the output signal, and the interference result includes a first result based on the interference between the first FMCW signal within the LO signal and the first component of the return signal and a second result based on the interference between the second FMCW signal within the LO signal and the second component of the return signal.

In addition to one or more of the features described herein, the system is monostatic and includes a circulator to direct the output signal to and the return signal from a same one of the one or more aperture lenses.

In addition to one or more of the features described herein, the system is bistatic and a first one of the one or more aperture lenses transmits the output signal and a second one of the one or more aperture lenses obtains the return signal.

In addition to one or more of the features described herein, the system is within or on a vehicle and is configured to detect a location and speed of the target relative to the vehicle.

In another exemplary embodiment, a method of assembling a coherent lidar system includes arranging a first light source and a second light source to respectively output a first continuous wave and a second continuous wave, and disposing a first modulator and a second modulator to respectively modulate a frequency of the first continuous wave and the second continuous wave to respectively provide a first frequency modulated continuous wave (FMCW) signal and a second FMCW signal. The method also includes arranging a beam combiner to combine the first FMCW signal and the second FMCW signal into a combined FMCW signal, and arranging one or more aperture lenses to transmit an output signal obtained from the combined FMCW signal and to obtain a return signal resulting from a reflection of the output signal by a target.

In addition to one or more of the features described herein, the method also includes arranging a beam splitter to split the combined FMCW signal into the output signal and a local oscillator (LO) signal.

In addition to one or more of the features described herein, the method also includes disposing an alignment element to align the LO signal and the return signal to produce a co-linear signal, and arranging two or more photodetectors to obtain an interference result based on interference between the LO signal and the return signal in the co-linear signal.

In yet another exemplary embodiment, a vehicle includes a coherent lidar system that includes a first light source and a second light source to respectively output a first continuous wave and a second continuous wave, and a first modulator and a second modulator to respectively modulate a frequency of the first continuous wave and the second continuous wave to respectively provide a first frequency modulated continuous wave (FMCW) signal and a second FMCW signal. The system also includes a beam combiner to combine the first FMCW signal and the second FMCW signal into a combined FMCW signal, and one or more aperture lenses to transmit an output signal obtained from the combined FMCW signal and to obtain a return signal resulting from a reflection of the output signal by a target. The vehicle also includes a vehicle controller to augment or automate operation of the vehicle based on information from the coherent lidar system.

In addition to one or more of the features described herein, wherein the first FMCW signal is a first triangle wave with increasing frequency followed by decreasing frequency and the second FMCW signal is a second triangle wave with decreasing frequency followed by increasing frequency.

In addition to one or more of the features described herein, the first triangle wave and the second triangle wave are concurrent in the combined FMCW signal such that the increasing frequency in the first triangle wave is simultaneous with the decreasing frequency in the second triangle wave and the decreasing frequency in the first triangle wave is simultaneous with the increasing frequency in the second triangle wave.

In addition to one or more of the features described herein, the coherent lidar system also includes a beam splitter to split the combined FMCW signal into the output signal and a local oscillator (LO) signal.

In addition to one or more of the features described herein, the coherent lidar system also includes an alignment element to align the LO signal and the return signal to produce a co-linear signal.

In addition to one or more of the features described herein, the coherent lidar system also includes two or more photodetectors to obtain an interference result based on interference between the LO signal and the return signal in the co-linear signal.

In addition to one or more of the features described herein, the return signal includes a first component associated with the first FMCW signal in the output signal and a second component associated with the second FMCW signal in the output signal, and the interference result includes a first result based on the interference between the first FMCW signal within the LO signal and the first component of the return signal and a second result based on the interference between the second FMCW signal within the LO signal and the second component of the return signal.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a scenario involving a coherent lidar system according to one or more embodiments;

FIG. 2 details the generation of a frequency modulated continuous wave (FMCW) signal in the lidar system according to an exemplary embodiment;

FIG. 3 is a block diagram detailing components of the lidar system with alternating chirps according to one or more embodiments;

FIG. 4 is a block diagram detailing components of the lidar system with alternating chirps according to one or more embodiments;

FIG. 5 illustrates the result of transmitting alternating chirps according to an exemplary embodiment; and

FIG. 6 shows exemplary beat frequencies resulting from transmitting alternating chirps according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a lidar system may be one of several sensors that provide information to augment vehicle operation or operate an autonomous vehicle. As also noted, a coherent lidar system, which relies on phase coherence between a source signal output by the light source, also referred to as the local oscillator (LO), and the resulting return signal reflected from a target, generally transmits a chirp that includes an upchirp and a downchirp in the shape of a triangle wave. Embodiments of the systems and methods detailed herein relate to an alternating chirp FMCW Doppler lidar. Transmission of a triangle wave facilitates the simultaneous measurement of range and relative Doppler velocity of a target, because two separate coherent frequencies are present to disentangle the two measurements. As detailed, according to the embodiments, two light sources are used to generate output signals that are combined or otherwise transmitted simultaneously. The two output signals with alternating chirp signals take advantage of the fact that the two separate coherent frequencies used to determine target range and relative Doppler velocity need not originate from the same light source. Because the frequency shifts in the return signal during both the upchirp and the downchirp are used to determine target range and relative velocity, simultaneously transmitting an upchirp and a downchirp means that the same information may be obtained in less time. Alternately, more information may be obtained in the same duration, thereby increasing the SNR.

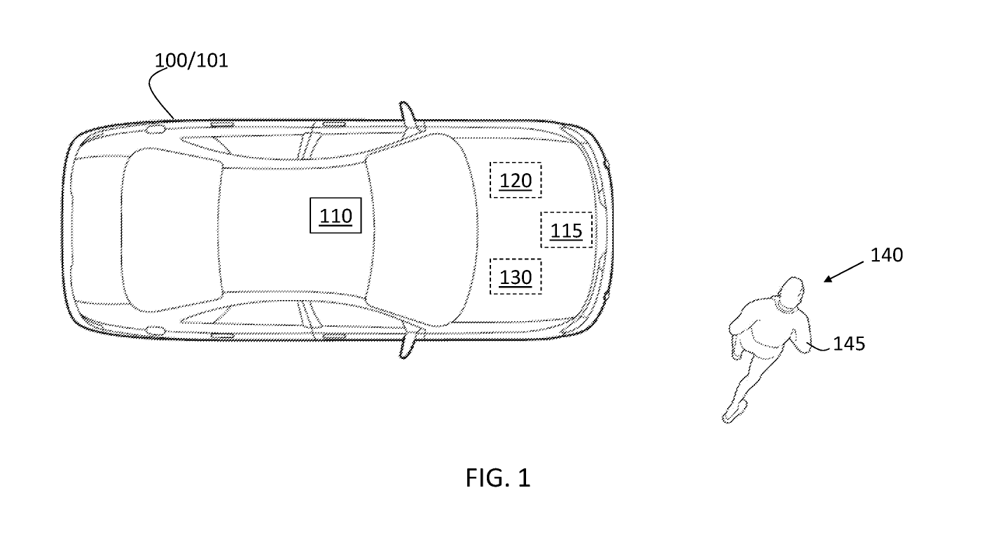

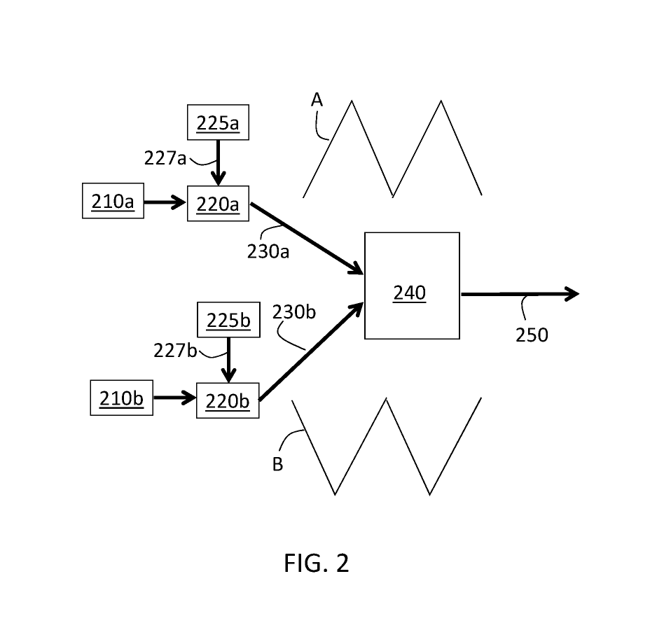

In accordance with an exemplary embodiment, FIG. 1 is a block diagram of a scenario involving a coherent lidar system 110. The vehicle 100 shown in FIG. 1 is an automobile 101. A coherent lidar system 110, further detailed with reference to FIG. 2, is shown on the roof of the automobile 101. According to alternate or additional embodiments, one or more lidar systems 110 may be located elsewhere on the vehicle 100. Portions of the lidar system 110 may be housed within the vehicle 100. Another sensor 115 (e.g., camera, microphone, radar system) is shown, as well. Information obtained by the lidar system 110 and one or more other sensors 115 may be provided to a controller 120 (e.g., electronic control unit (ECU)).

The controller 120 may use the information to control one or more vehicle systems 130. In an exemplary embodiment, the vehicle 100 may be an autonomous vehicle controlled, at least in part, by the controller 120. The lidar system 110 and one or more other sensors 115 may be used to detect objects 140, such as the pedestrian 145 shown in FIG. 1. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 details the generation of an FMCW signal 250 in the lidar system 110 according to an exemplary embodiment. Two light sources 210a, 210b (generally referred to as 210), two optical resonators 220a, 220b (generally referred to as 220), and two voltage sources 225a, 225b (generally referred to as 225) are shown. Each of the voltage sources 225a, 225b outputs a respective controlled voltage 227a, 227b (generally referred to as 227). Each light source 210 may be a laser diode such as a distributed feedback (DFB) laser according to an exemplary embodiment. Each light source 210 outputs a continuous wave of light, which exhibits a constant amplitude, to the corresponding optical resonator 220. Each of the optical resonators 220 is an external optical cavity, external to the light source 210. According to the exemplary embodiment shown in FIG. 2, a controlled voltage 227 is applied to each optical resonator 220 to perform electro-optical modulation and modulate the frequency of the continuous wave of light in the resonator 220. As FIG. 2 indicates the modulation results in modulated light 230a based on light source 210a and modulated light 230b based on light source 210b.

According to the exemplary embodiment, the feedback of some light from each optical resonator 220 to the corresponding light source 210 means that the light generated within the light source 210 and the light output by the optical resonator 220 are modulated synchronously. The controlled voltage 227 may be increased or decreased linearly in order to produce light that exhibits linear frequency modulation (i.e., a linear FMCW signal). In alternate embodiments, the controlled voltage 227 may be varied non-linearly to produce light that exhibits non-linear frequency modulation. In still further embodiments, each light source 210 itself may be modulated. That is, each controlled voltage 227 may be applied to the corresponding light source 210 rather than to the optical resonator 220. For example, the bias current of the laser chip may be changed or a physical cavity or mirror of the light source 210 may be modulated. This modulation may be implemented by piezoelectric or microelectromechanical systems (MEMS) actuation, for example.

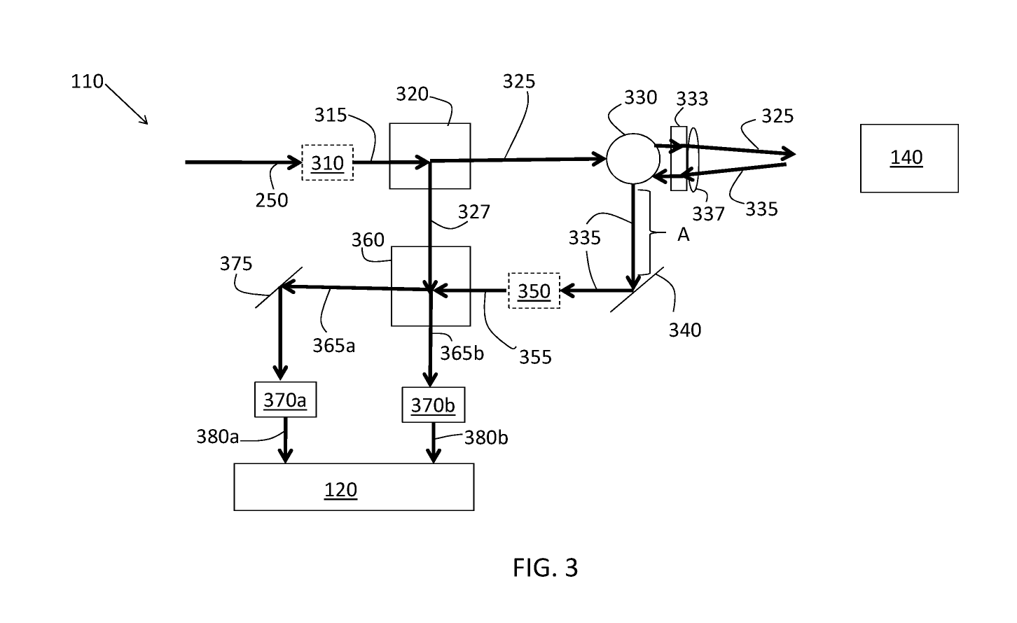

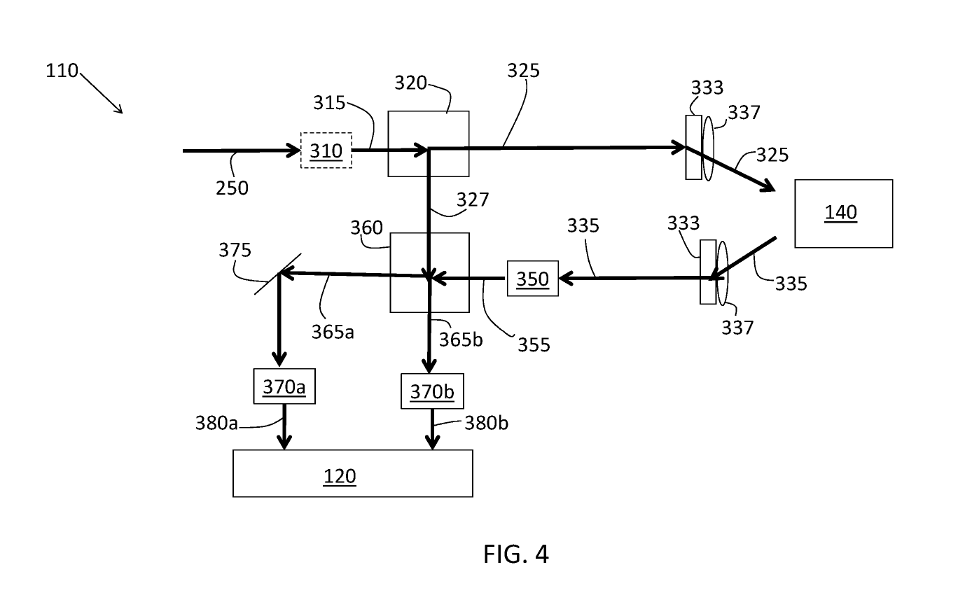

The modulated light 230a and the modulated light 230b exhibit frequency modulation that is opposite to each other (i.e., 180 degrees out of phase with each other) in FIG. 2. That is, an upchirp (e.g., A) in the modulated light 230a corresponds in time with a downchirp (e.g., B) in the modulated light 230b and vice versa. Thus, the modulated light 230a and the modulated light 230b may be referred to as alternating chirp signals. The modulated light 230a and the modulated light 230b are combined using a beam combiner 240 to produce FMCW light 250. The beam combiner 240 may be, for example, a beam splitter, a 2×1 fiber coupler, or a 2×1 waveguide coupler. In alternate embodiments, the modulated light 230a and the modulated light 230b may be transmitted individually using systems discussed with reference to FIGS. 3 and 4. However, such an embodiment would require double the number of components.

FIG. 3 is a block diagram detailing components of the lidar system 110 with alternating chirps according to one or more embodiments. The lidar system 110 may be implemented with free-standing optical elements or using on-chip integration. The FMCW light 250 that is a combination of the modulated light 230a and the modulated light 230b is provided to an optional optical amplifier 310 that amplifies the FMCW light 250 to produce an FMCW signal 315. The FMCW signal 315 is input to a beam splitter 320 that splits the FMCW signal 315 into an output signal 325 and a local oscillator (LO) signal 327. The output signal 325 and the LO signal 327 are identical signals that exhibit the alternating chirps based on the modulated light 230a and the modulated light 230b. The beam splitter 320 may be an on-chip waveguide splitter, for example. The beam splitter 320 may alternately be off-chip. The output signal 325 is provided to a light circulating element such as the circulator 330. The circulator 330 is positioned in a monostatic system such as the one shown in FIG. 3 to direct the output signal 325 from the transmit path out of the lidar system 110 and to direct the incoming return signal 335 to the receive path.

The output signal 325 from the circulator 330 is directed or aimed by a beam steering device 333 through an aperture lens 337. The output signal 325 is scattered by the target 140. Some of that scattered light reenters the lidar system 110 as the return signal 335. The return signal 335 enters through the aperture lens 337 and is directed by the beam steering device 333 to the circulator 330, which directs the return signal 335 to the receive path. According to the exemplary arrangement shown in FIG. 3, the receive path includes a reflector 340. The reflector 340 directs the return signal 335 to an optional optical amplifier 350. The optical amplifier 350 may be along the path indicated as A instead of after the reflector 340 according to alternate embodiments. The amplified return signal 355 is provided to an alignment element 360.

The amplified return signal 335 is aligned with the LO signal 327 in the alignment element 360. The alignment element 360 ensures that the amplified return signal 355 and the LO signal 327 are co-linear and splits the aligned signals into co-linear signals 365a, 365b (generally referred to as 365). Each co-linear signal 365 is directed to a corresponding photodetector 370a, 370b (generally referred to as 370). A reflector 375 may direct the co-linear signal 365a into the photodetector 370a, as shown in FIG. 3. The amplified return signal 355 and the LO signal 327, which are aligned in the co-linear signals 365, interfere with each other in each photodetector 370. The interference between the amplified return signal 355 and the LO signal 327 results in coherent combination of the two beams. Thus, the lidar system 110 is referred to as a coherent lidar system. The interference in each photodetector 370 represents an autocorrelation function to identify an amplified return signal 355 that resulted from the output signal 325. This prevents errant light from another light source outside the lidar system 110 that is within the field of view of the lidar system 110 from being mistaken for a return signal 335 that is reflected by a target 140. The result of the interference in the photodetectors 370 is the frequency shift, referred to as a beat frequency, between a transmitted output signal 325 and corresponding return signal 335.

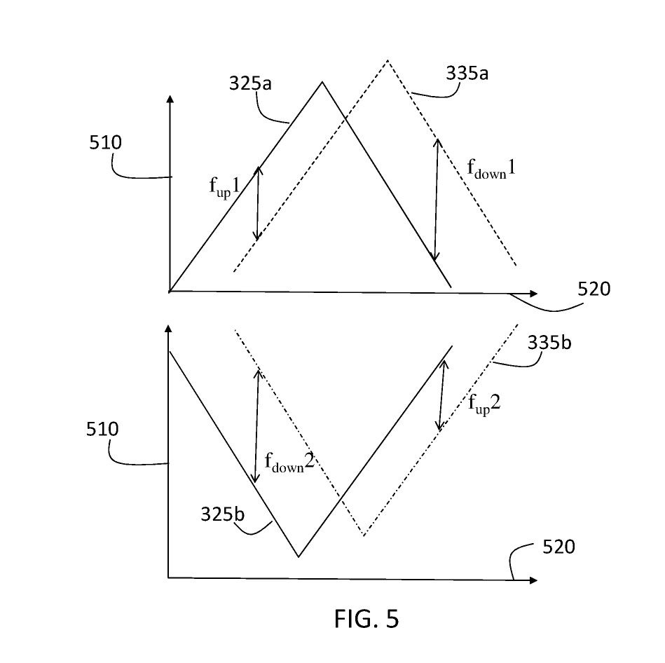

The photodetectors 370 are semiconductor devices that convert the result of the interference between the amplified return signal 355 and the LO signal 327 in the co-linear signals 365 into electrical currents 380a, 380b (generally referred to as 380). Two photodetectors 370 are used in accordance with a known balanced detector technique to cancel noise that is common in each path to both photodetectors 370. The electrical currents 380 from each photodetector 370 are combined and processed to obtain information like range to the target 140, speed of the target 140, intensity of the target, and other information according to known processing techniques. The processing may be performed within the lidar system 110 or outside the lidar system 110 by the controller 120, for example. The processing is further discussed with reference to FIG. 5.

FIG. 4 is a block diagram detailing components of the lidar system 110 with alternating chirps according to one or more embodiments. The lidar system 110 shown in FIG. 4 is a bistatic system with separate aperture lenses 337 used to transmit the output signal 325 and to obtain the return signal 335. As such a circulator 330 is not needed in the bistatic system of FIG. 4, unlike the monostatic system shown in FIG. 3. The other components of the system are the same as those discussed with reference to FIG. 3. Thus, the components detailed with reference to FIG. 3 are not discussed again.

FIG. 5 illustrates the result of transmitting alternating chirps according to an exemplary embodiment. Even though the output signals 325a and 325b resulting, respectively, from light sources 210a and 210b, are shown on two separate graphs for clarity, a single combined output signal 325 with both components may be transmitted as shown in FIGS. 3 and 4. The resulting return signal 335 would have the components of the return signal 335a resulting from output signal 325a and the return signal 335b resulting from the output signal 325b. Frequency is along axis 510, and time is shown along axis 520. Both output signals 325a, 325b begin at the same time. The frequency change between the output signal 325a and resulting return signal 335a in the upchirp portion (i.e., the beat frequency) is indicated as fᵤₚ1, and the beat frequency associated with the output signal 325a and resulting return signal 335a in the downchirp portion is indicated as f_{down}1. Similarly, the beat frequency associated with the output signal 325b and resulting return signal 335b in the downchirp portion is indicated as f_{down}2, and the beat frequency resulting from interference of the output signal 325b with the resulting return signal 335b in the upchirp portion is indicated as fᵤₚ2. It should be clear that there is no beat frequency between output signal 325a and return signal 335b or between output signal 325b and return signal 335a. This is because there is no phase coherence between the light sources 210 such that there is no phase coherence between a signal originating from one of the light sources 210 and a reflection resulting from transmission of a signal from the other light source 210.

If only the output signal 325a were used, as in a conventional coherent lidar system, the range to the target 140 that generated the return signal 335a would be computed as:

$$R = \frac{c ( {f}_{down} 1 + {f}_{up} 1 )}{4 ξ} \qquad [ EQ . 1 ]$$

The relative velocity of the target 140 to the lidar system 110 would be given by:

$$Δ v = \frac{λ ( {f}_{down} 1 - {f}_{up} 1 )}{2} \qquad [ EQ . 2 ]$$

In EQ. 1, c is the speed of light, and ξ is the rate of frequency change over time. In EQ. 2, λ is the wavelength of the output signal 225a. As indicated by EQS. 1 and 2, if only the output signal 225a is transmitted, the time to transmit both the upchirp and downchirp portions of the output signal 225a and to receive the return signal 335a resulting from both portions must be taken. However, by using the alternating chirps (i.e., transmitting output signals 225a, 225b simultaneously), the range and relative velocity may be determined as follows:

$$\begin{matrix}R = \frac{c ( {f}_{down} 2 + {f}_{up} 1 )}{4 ξ} & [ EQ . 3 ] \\ Δ v = \frac{λ ( {f}_{down} 2 - {f}_{up} 1 )}{2} & [ EQ . 4 ]\end{matrix}$$

It should be clear that f_{down}1 and fᵤₚ2 may be used instead of f_{down}2 and fᵤₚ1 in EQS. 3 and 4.

As EQS. 3 and 4 indicate, the range and relative velocity of the target 140 can be determined in only the time it takes to transmit the simultaneously transmitted upchirp portion of output signal 225a and the downchirp portion of output signal 225b (or the downchirp portion of output signal 225a and the upchirp portion of output signal 225b) and to obtain the associated portions of the return signals 335a, 335b. This provides two range and velocity measurements in the time it would take to make a single measurement with a single upchirp and downchirp. Viewed another way, using both the upchirp and downchirp portions of each of the output signals 225a, 225b and subsequent return signals 335a, 335b, according to the embodiments detailed herein, results in doubling the number of measurements that can be obtained in the same time measurements. Thus, the exemplary scheme increases the measurement rate by a factor of two. Accordingly, either the spatial resolution is improved or the measurement rate at the same resolution may be increased by a factor of two.

In alternate embodiments, the scheme described above can be performed with multiple pairs of light sources 210, provided that the total period of time (T) for the multiple chirps does not exceed the roundtrip time of light to and from the maximum reported target range (Rmax) to the lidar system 110, as given by T≥2 Rmax/c.

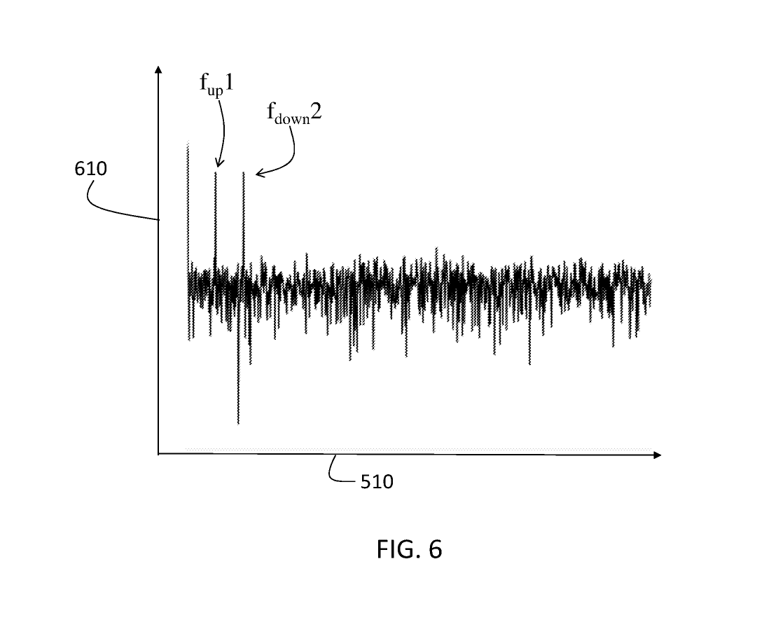

FIG. 6 shows exemplary beat frequencies during a single acquisition resulting from transmitting alternating chirps according to an exemplary embodiment. Frequency is shown along axis 510 and signal strength in decibels (dB) is shown along axis 610. As previously noted, each return signal 335a, 335b (or amplified return signals 355 in the case when the optional optical amplifier 350 is used) will only interfere with the portion of the LO signal 327 that pertains to the corresponding output signal 325a, 325b. The frequencies fᵤₚ1, f_{down}1 are the beat frequencies obtained at the photodetectors 370 based on the interference of the LO signal 237 (specifically, the part of the LO signal 237 that corresponds with output signal 325a) with the portion of the return signal 335 that corresponds with return signal 335a. The frequencies f_{down}2, fᵤₚ2 are the beat frequencies obtained at the photodetectors 370 based on the interference of the LO signal 237 (specifically, the part of the LO signal 237 that corresponds with output signal 325b) with the portion of the return signal 335 that corresponds with return signal 335b. As FIG. 5 indicates, because the upchirp of output signal 325a and the downchirp of output signal 325b are transmitted simultaneously and before the downchirp of output signal 325a and the upchirp of output signal 325b, the beat frequencies fᵤₚ1 and f_{down}2 are obtained before beat frequencies f_{down}1 and fᵤₚ2.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A coherent lidar system, comprising:
a first light source and a second light source configured to respectively output a first continuous wave and a second continuous wave;
a first modulator and a second modulator configured to respectively modulate a frequency of the first continuous wave and the second continuous wave to respectively provide a first frequency modulated continuous wave (FMCW) signal and a second FMCW signal;
a beam combiner configured to combine the first FMCW signal and the second FMCW signal into a combined FMCW signal; and
one or more aperture lenses configured to transmit an output signal obtained from the combined FMCW signal and to obtain a return signal resulting from a reflection of the output signal by a target.

2. The system according to claim 1, wherein the first FMCW signal is a first triangle wave with increasing frequency followed by decreasing frequency and the second FMCW signal is a second triangle wave with decreasing frequency followed by increasing frequency.

3. The system according to claim 2, wherein the first triangle wave and the second triangle wave are concurrent in the combined FMCW signal such that the increasing frequency in the first triangle wave is simultaneous with the decreasing frequency in the second triangle wave and the decreasing frequency in the first triangle wave is simultaneous with the increasing frequency in the second triangle wave.

4. The system according to claim 1, further comprising a beam splitter configured to split the combined FMCW signal into the output signal and a local oscillator (LO) signal.

5. The system according to claim 4, further comprising an alignment element configured to align the LO signal and the return signal to produce a co-linear signal.

6. The system according to claim 5, further comprising two or more photodetectors configured to obtain an interference result based on interference between the LO signal and the return signal in the co-linear signal.

7. The system according to claim 6, wherein the return signal includes a first component associated with the first FMCW signal in the output signal and a second component associated with the second FMCW signal in the output signal, and the interference result includes a first result based on the interference between the first FMCW signal within the LO signal and the first component of the return signal and a second result based on the interference between the second FMCW signal within the LO signal and the second component of the return signal.

8. The system according to claim 1, wherein the system is monostatic and includes a circulator to direct the output signal to and the return signal from a same one of the one or more aperture lenses.

9. The system according to claim 1, wherein the system is bistatic and a first one of the one or more aperture lenses transmits the output signal and a second one of the one or more aperture lenses obtains the return signal.

10. The system according to claim 1, wherein the system is within or on a vehicle and is configured to detect a location and speed of the target relative to the vehicle.

11. A method of assembling a coherent lidar system, comprising:
arranging a first light source and a second light source to respectively output a first continuous wave and a second continuous wave;
disposing a first modulator and a second modulator to respectively modulate a frequency of the first continuous wave and the second continuous wave to respectively provide a first frequency modulated continuous wave (FMCW) signal and a second FMCW signal;
arranging a beam combiner to combine the first FMCW signal and the second FMCW signal into a combined FMCW signal; and
arranging one or more aperture lenses to transmit an output signal obtained from the combined FMCW signal and to obtain a return signal resulting from a reflection of the output signal by a target.

12. The method according to claim 11, further comprising arranging a beam splitter to split the combined FMCW signal into the output signal and a local oscillator (LO) signal.

13. The method according to claim 12, further comprising disposing an alignment element to align the LO signal and the return signal to produce a co-linear signal, and arranging two or more photodetectors to obtain an interference result based on interference between the LO signal and the return signal in the co-linear signal.

14. A vehicle, comprising:
a coherent lidar system comprising:
a first light source and a second light source configured to respectively output a first continuous wave and a second continuous wave;
a first modulator and a second modulator configured to respectively modulate a frequency of the first continuous wave and the second continuous wave to respectively provide a first frequency modulated continuous wave (FMCW) signal and a second FMCW signal;
a beam combiner configured to combine the first FMCW signal and the second FMCW signal into a combined FMCW signal; and
one or more aperture lenses configured to transmit an output signal obtained from the combined FMCW signal and to obtain a return signal resulting from a reflection of the output signal by a target; and
a vehicle controller configured to augment or automate operation of the vehicle based on information from the coherent lidar system.

15. The vehicle according to claim 14, wherein the first FMCW signal is a first triangle wave with increasing frequency followed by decreasing frequency and the second FMCW signal is a second triangle wave with decreasing frequency followed by increasing frequency.

16. The vehicle according to claim 15, wherein the first triangle wave and the second triangle wave are concurrent in the combined FMCW signal such that the increasing frequency in the first triangle wave is simultaneous with the decreasing frequency in the second triangle wave and the decreasing frequency in the first triangle wave is simultaneous with the increasing frequency in the second triangle wave.

17. The vehicle according to claim 14, wherein the coherent lidar system further comprises a beam splitter configured to split the combined FMCW signal into the output signal and a local oscillator (LO) signal.

18. The vehicle according to claim 17, wherein the coherent lidar system further comprises an alignment element configured to align the LO signal and the return signal to produce a co-linear signal.

19. The vehicle according to claim 18, wherein the coherent lidar system further comprises two or more photodetectors configured to obtain an interference result based on interference between the LO signal and the return signal in the co-linear signal.

20. The vehicle according to claim 19, wherein the return signal includes a first component associated with the first FMCW signal in the output signal and a second component associated with the second FMCW signal in the output signal, and the interference result includes a first result based on the interference between the first FMCW signal within the LO signal and the first component of the return signal and a second result based on the interference between the second FMCW signal within the LO signal and the second component of the return signal.
